(19) United States
(12) Patent Application Publication
(10) Pub. No.: US 2021/0406821 A1
(43) Pub. Date: Dec. 30, 2021

(54) ELECTRONIC DEVICE FOR MANAGING DELIVERY AND CONTROLLING METHOD THEREOF

(71) Applicant: Coupang Corp., Seoul (KR)

(72) Inventors: Yul Hee Lee, Seoul (KR); Bo Ra Moon, Seoul (KR); Joo Ran Jang, Seoul (KR); Ho Yeon Bae, Seoul (KR); Hye Bin Lee, Seoul (KR); Young Soo Lim, Seoul (KR); Yeon Jung Jo, Seoul (KR); Yeong Soo Kim, Seoul (KR); Young Jin Kim, Seoul (KR); Jeong Ho Pi, Seoul (KR); Yoo Cheol Na, Seoul (KR); Soon Ho Hong, Seoul (KR); Han Sol Kim, Seoul (KR)

(21) Appl. No.: 17/022,653

(22) Filed: Sep. 16, 2020

(30) Foreign Application Priority Data
Jun. 24, 2020 (KR) 10-2020-0077239

(51) Int. Cl. G06Q 10/08; G06Q 50/30

(52) U.S. Cl. CPC G06Q 10/0833; G06Q 50/30; G06Q 10/0835

(57) ABSTRACT

Provided is an electronic apparatus for managing a delivery and a control method thereof, the method including identifying a misdelivery event, identifying delivery information corresponding to the misdelivery event and information regarding a courier, identifying, based on the identified information on the courier, whether the courier is available, and, when the courier is available, transmitting the delivery information corresponding to the misdelivery event to a first terminal corresponding to the courier.

### BACKGROUND

### Technical Field

The present disclosure relates to an electronic apparatus for managing a delivery associated with a misdelivery event based on identification of the misdelivery event, and a control method thereof.

### Description of the Related Art

As the use of the Internet becomes is universal, the e-commerce market is growing. In the e-commerce market, since transactions are made online, a delivery service for transporting items which are paid is accompanied. The delivery service is a service in which a courier delivers an ordered item to a delivery address input by a customer. That is, the courier provides the delivery service by identifying the delivery address and delivering the item to the address representing a delivery location.

However, in some cases, a misdelivery event may occur in which an item is delivered to a wrong delivery address other than a delivery address input by a customer due to a mistake of the courier. In this case, reshipment is required to deliver the item normally to the customer. In this case, it takes a longer time to deliver the item than initially expected, which may cause inconvenience to the customer.

Therefore, there is a need for a method for managing a delivery to minimize inconvenience to a user when a misdelivery event occurs.

### SUMMARY

### Technical Goals

An aspect provides an electronic apparatus and a control method thereof, the apparatus which enables processing for an item corresponding to a misdelivery event based on availability of a courier so that the misdelivery event can be managed more effectively by reflecting a delivery situation associated with the misdelivery event.

Technical goals to be achieved through the example embodiments are not limited to the technical goals as described above, and other technical tasks can be inferred from the following example embodiments.

### Technical Solutions

According to a first embodiment, there is provided a control method of an electronic apparatus for managing a delivery, the method including identifying a misdelivery event, identifying delivery information corresponding to the misdelivery event and information on or regarding a courier, identifying, based on the identified information on or regarding the courier, whether the courier is available, and, when the courier is available, transmitting the delivery information corresponding to the misdelivery event to a first terminal corresponding to the courier.

According to the second embodiment, there is provided an electronic apparatus for managing a delivery, the apparatus including a transceiver, a memory, and a processor, and the processor is configured to identify a misdelivery event, identify delivery information corresponding to the misdelivery event and information on a courier, identify, based on the identified information on the courier, whether the courier is available, and, when the courier is available, transmit the delivery information corresponding to the misdelivery event to a first terminal corresponding to the courier.

According to a third embodiment, there is provided a non-transitory computer-readable recording medium having recorded thereon a program, which, when executed by a computer, performs a control method of an electronic apparatus, and the control method includes identifying a misdelivery event, identifying delivery information corresponding to the misdelivery event and information on or regarding a courier, identifying, based on the identified information on the courier, whether the courier is available, and when the courier is available, transmitting the delivery information corresponding to the misdelivery event to a first terminal corresponding to the courier.

Details of other embodiments are included in the detailed description and drawings.

### Effects

According to the present disclosure, an electronic apparatus and a control method thereof enables processing for an item corresponding to a misdelivery event based on whether a courier is available, and therefore, it is possible to manage the misdelivery event more effectively by reflecting a delivery situation associated with the misdelivery event.

In addition, the electronic apparatus and the control method thereof identify delivery information corresponding to the misdelivery event and information on or regarding the courier in response to identifying the misdelivery event, and therefore, it is possible to provide more accurate information associated with the misdelivery event to a customer and enable more effective management for the misdelivery event.

Effects of the present disclosure are not limited to the effects mentioned above, and other effects not mentioned will become apparent to those skilled in the art from the description of the claims.

### BRIEF DESCRIPTION OF THE DRAWINGS

FIG. 1 is a conceptual diagram illustrating a connection relationship between electronic apparatuses according to an embodiment.

FIG. 2 is a functional block diagram of an electronic apparatus according to an embodiment.

FIG. 3 is a flowchart of a control method of an electronic apparatus according to an embodiment.

FIGS. 4 to 6 are diagrams for describing a screen provided at an electronic apparatus according to an embodiment.

FIGS. 7 and 8 are diagrams for describing an example in which information provided from an electronic apparatus is displayed on a first terminal corresponding to a courier according to an embodiment.

FIG. 9 is a diagram for describing another example in which information provided from an electronic apparatus is displayed on a first terminal corresponding to a courier according to an embodiment.

FIG. 10 is a diagram for describing yet another example in which information provided from an electronic apparatus is displayed on a first terminal corresponding to a courier according to an embodiment.

FIG. 11 is a diagram illustrating an example of response information received from a first terminal of an electronic apparatus according to an embodiment.

### DETAILED DESCRIPTION

Terms used in embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element.

Throughout the specification, the expression “at least one of A, B, and C” may include the following meanings: A alone; B alone; C alone; both A and B together; both A and C together; both B and C together; and all three of A, B, and C together.

The term “terminal” mentioned below may be implemented as a computer or a portable terminal capable of accessing a server or another terminal through a network. Here, the computer may include, for example, a laptop computer, a desktop computer, and a notebook equipped with a web browser. The portable terminal may be a wireless communication device ensuring a portability and a mobility, and include any type of handheld wireless communication device, for example, a tablet PC, a smartphone, a communication-based terminal such as international mobile telecommunication (IMT), code division multiple access (CDMA), W-code division multiple access (W-CDMA), and long term evolution (LTE).

In the following description, embodiments of the present disclosure will be described in detail with reference to the drawings so that those skilled in the art can easily carry out the present disclosure. However, the present disclosure may be implemented in various different forms but it is not limited to the exemplary embodiments described herein.

Hereinafter, example embodiments of the present disclosure will be described with reference to the drawings.

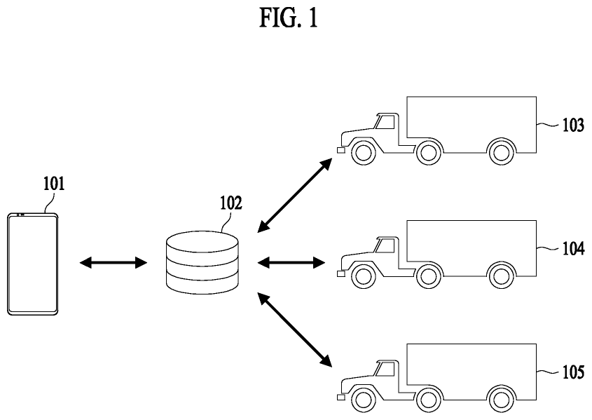

FIG. 1 is a conceptual diagram illustrating a connection relationship between electronic apparatuses according to an embodiment. Specifically, FIG. 1 conceptually illustrates a connection relationship between a customer terminal 101, an electronic apparatus 102, and a plurality of courier terminals 103, 104, and 105.

When an item transaction is made through a website, an item transaction manager (e.g., a seller of an item, a delivery manager of the website) may ship an ordered item to a delivery location requested by a customer. In this case, an electronic apparatus corresponding to the customer may correspond to the customer terminal 101 of FIG. 1, and an electronic apparatus corresponding to the item transaction manager may correspond to the electronic apparatus 102 of FIG. 1, and an electronic apparatus for a courier delivering the ordered item may correspond to a courier terminal (e.g., a first courier terminal 103) of FIG. 1. The customer terminal 101, the electronic apparatus 102, or the courier terminal (e.g., the first courier terminal 103, a second courier terminal 104, and a third courier terminal 105) may include, for example, but not limited to, a mobile terminal, a tablet, or a desktop, and may include various types of electronic apparatus.

In some cases, the electronic apparatus 102 may include a server. For example, the electronic apparatus 102 may include a server associated with the website. In this case, the electronic apparatus 102 may acquire input information based on a connection with another electronic apparatus corresponding to the item transaction manager or a connection with the customer terminal 101. Here, the input information may include at least part of delivery information associated with a misdelivery event. For example, the input information may be at least one: order information for an item that has been misdelivered; a delivery correction request time for a misdelivery event; a delivery correction request deadline for a misdelivery event; and an item processing method responsive to a failure of a delivery correction for a misdelivery event.

Meanwhile, the “item transaction” related to the embodiments of the present specification is not limited to a transaction through a website, that is, e-commerce, and may include various transactions involving an item delivery service, for example, a home shopping transaction. In addition, the item transaction manager may include, for example, but not limited to, a person who manages item delivery, a person who has been entrusted with the right for delivery management, or a customer service agent of a website.

Meanwhile, an order of an item may be placed through a website from a plurality of customers, and if the plurality of customers who ordered items is at different locations, a plurality of couriers each may deliver an item to a different customer. A courier for delivering an ordered item, or the courier's terminal may be predetermined based on a delivery address requested by a customer who ordered the item.

The plurality of courier terminals 103, 104, and 105 of FIG. 1 may include terminals corresponding to the plurality of couriers, respectively. That is, the first courier terminal may be a terminal corresponding to a first courier, the second courier terminal may be a terminal corresponding to a second courier, the third courier terminal may be a terminal corresponding to a third courier, and at least one courier terminal may be omitted or another courier terminal may be added according to an embodiment. Since e-commerce including the above-described transactions through a website, and a delivery service involved in the e-commerce are apparent to those skilled in the art, a detailed description will be omitted.

Referring to FIG. 1, the electronic apparatus 102 may be connected to at least one of the customer terminal 101 and the plurality of courier terminals 103, 104, and 105. The customer terminal 101 may include a terminal of a customer corresponding to an item to be delivered by a courier corresponding to one of the plurality of courier terminals 103, 104, and 105 (e.g., the first courier terminal 103). The electronic apparatus 102 may transmit and receive a variety of information associated with a misdelivery event to and from at least one of the customer terminal 101 and the plurality of courier terminals 103, 104, and 105 based on a connection therewith.

For example, the electronic apparatus 102 may receive delivery information corresponding to a misdelivery event from the customer terminal 101 based on the connection with the customer terminal 101 and may provide information associated with a delivery correction to the customer terminal 101. Delivery information corresponding to the misdelivery event may include a variety of information associated with a misdelivery.

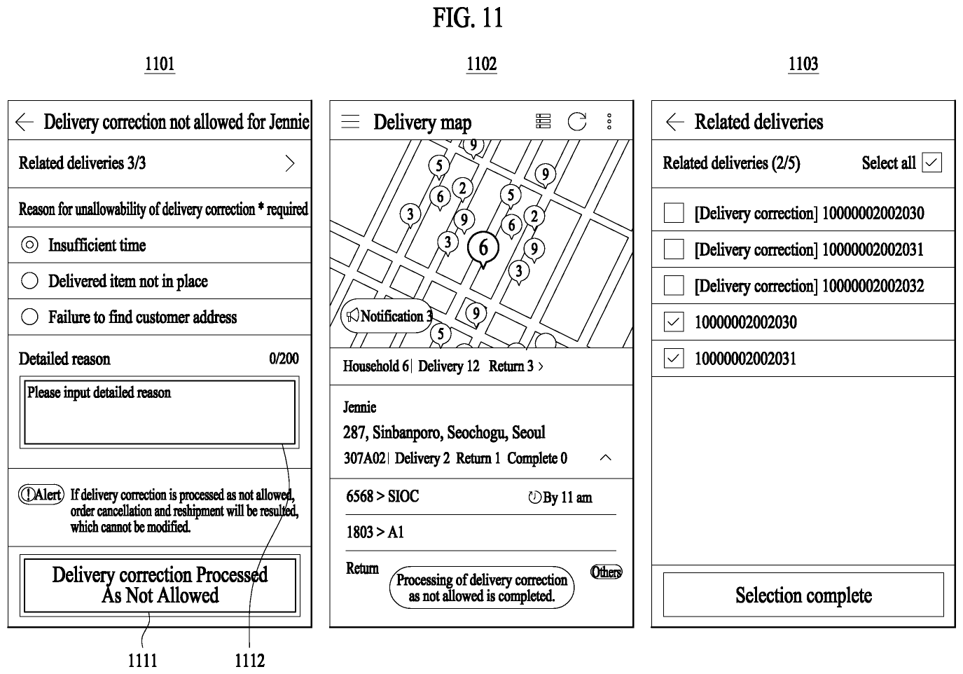

In another example, the electronic apparatus 102 may transmit information associated with a misdelivery event to the first courier terminal 103 based on the connection with the first courier terminal 103 and may receive response information corresponding to delivery information from the first courier terminal 103. The response information received from the first courier terminal 103 is, for example, processing information associated with a misdelivery, and may include at least one of: information indicating unallowability of processing a delivery correction for the misdelivery event; and information indicating a reason for the unallowability of the processing. The response information may be generated based on an input by the courier corresponding to the courier terminal, and a specific example related to the input by the courier may be referred to FIG. 11.

In the embodiment, the electronic apparatus 102 may include an electronic apparatus of a customer service agent who is on the phone with a customer based on a wired or wireless connection with the customer terminal 101. Specifically, the electronic apparatus 102 may include an electronic apparatus used by the customer service agent who is on the phone with the customer. The customer service agent may identify information associated with a misdelivery event from the customer based on the call with the customer and input the information into the electronic apparatus 102, and in response to the input by the customer service agent, the electronic apparatus 102 may identify delivery information associated with the misdelivery event. However, this is merely an example and the present disclosure is not limited thereto, and the electronic apparatus 102 may be connected to the customer terminal 101 and identify the information associated with the misdelivery event based on the customer's input.

In the embodiment, the electronic apparatus 102 may store a variety of information associated with items managed by the website. For example, the electronic apparatus 102 may store information on or regarding at least one of images photographed in response to a delivery status for each item, a delivery result for each item, a delivery location for each item, and completion of delivery for each item. Here, the information on or regarding at least one of the delivery status, the delivery result, and the image is transmitted from the terminal of a courier corresponding to the delivery of the item (e.g., the first courier terminal 103), and the delivery location may be acquired in response to the order of the item, but not limited thereto.

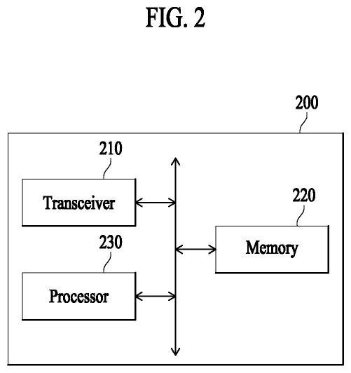

FIG. 2 is a functional block diagram of an electronic apparatus according to an embodiment. Although elements related to the present embodiment are shown in FIG. 2, the present disclosure is not limited thereto, and other general-purpose elements may be further included in addition to the elements shown in FIG. 2.

Referring to FIG. 2, an electronic apparatus 200 may include a transceiver 210, a memory 220, and a processor 230. Each element shown in FIG. 2 refers to a unit that processes at least one function or operation, which may be implemented by hardware or software, or a combination of hardware and software. For example, the transceiver 210 may be implemented by an operating device including a microprocessor, which is the same for the memory 220 and the processor 230.

In the embodiment, the electronic apparatus 200 of FIG. 2 may be implemented as a server, and the present specification is not limited by the implementation method of the electronic apparatus 200.

The transceiver 210 may be connected to another electronic apparatus so that information is transmitted and received between the electronic apparatus 200 and another electronic apparatus. For example, the electronic apparatus 200 may transmit information to another electronic apparatus or receive information from another electronic apparatus through the transceiver 210. Since a communication method of the transceiver 210 is apparent to a person skilled in the art, a detailed description thereof will be omitted.

The memory 220 may store a variety of data associated with the electronic apparatus 200. For example, the memory 220 may store at least one instruction for an operation of the electronic apparatus 200. In this case, the processor 230 may perform various operations based on instructions stored in the memory 220.

The processor 230 may control overall operations of the electronic apparatus 200. For example, the processor 230 may control an element of the electronic apparatus 200 based on an instruction stored in the memory 220 to control an operation of the electronic apparatus 200.

The processor 230 may identify a misdelivery event. For example, the processor 230 may identify the misdelivery event based on information received from a terminal (e.g., a customer terminal) corresponding to a customer associated with the misdelivery event. In another example, the processor 230 may identify the misdelivery event based on a user's input. In this case, the user's input may include an input corresponding to information indicating that an ordered item is misdelivered. The misdelivery event may include, for example, a case where an ordered item is misdelivered, that is, a case where the item is delivered to a delivery location other than a correct delivery location corresponding to the item.

The processor 230 may identify delivery information corresponding to the misdelivery event and information on or regarding a courier. When the misdelivery event is identified, the processor 230 may identify delivery information corresponding to the misdelivery event and the information on the courier.

In the embodiment, the delivery information corresponding to the misdelivery event may include at least one of: information identified based on a user's input; and information identified based on information stored in the electronic apparatus 200.

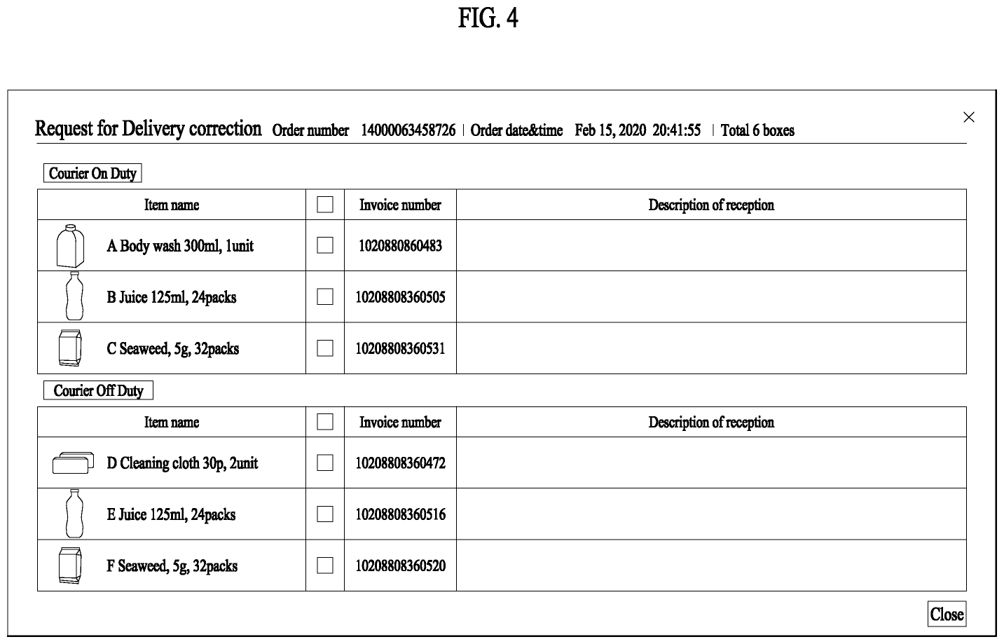

The delivery information corresponding to the information acquired based on the user's input may include, for example, information on or regarding at least one of: order information of an item, a delivery correction request time for the misdelivery event; a delivery correction request deadline for the misdelivery event; and an item processing method responsive to a failure of a delivery correction for the misdelivery event. For example, the order information of the item may include invoice information or order information which corresponds to a misdelivered item. The delivery correction request time may include a point of time when a delivery correction is requested when the delivery correction is requested by a customer. The delivery correction request deadline is a time for which completion of a delivery correction is requested, and may include, for example, within 3 hours from a time when the delivery correction is requested or before 5 pm. The item processing method is information on how to process the item when the delivery correction fails, and may include, for example, refund of the item or reshipment of the item. For a specific example, FIGS. 4 to 6 may be referred to. However, this is merely an example, and embodiments of the present specification are not limited to the above example.

The information identified based on the information stored in the electronic apparatus 200 may include, for example, at least one of: image information photographed in response to the misdelivery event; address information for a delivery correction in response to the misdelivery event; and image information associated with a delivery correction address. The image information photographed in response to the misdelivery event is image information of the item photographed at a wrong delivery location when the item is misdelivered, and may include image information that is stored in the electronic apparatus 200 based on transmission thereof from a courier terminal to the electronic apparatus 200 in response to the misdelivery. The address information for the delivery correction in response to the misdelivery event may include address information previously input by a customer, who ordered the item, to get the item delivered, that is, information on a correct delivery location. The image information associated with the delivery correction address may include image information photographed at a correct delivery location in response to a previous delivery which was correctly performed to the correct delivery location. The image information associated with the delivery correction address may include image information previously acquired from the courier terminal in response to the previous delivery. However, this is merely an example, and embodiments of the present specification are not limited to the above example.

Meanwhile, the delivery correction may refer to a case where an item incorrectly delivered to a wrong delivery location is re-delivered to a correct delivery location. In this case, the misdelivered item may be collected from the wrong delivery location and re-delivered to the correct delivery location, but the present disclosure is not limited thereto, and, for example, if the same item is included in a spare quantity, the item may be redelivered from the spare quantity.

The information on the courier may include, for example, at least one of: information on a courier who misdelivered the item; and information on a courier terminal corresponding to the courier who misdelivered the item.

The processor 230 may identify whether the courier is available, based on the identified information on the courier. Availability of the courier may include whether the courier is allowed to perform a delivery correction, for example.

In an embodiment, the processor 230 may identify whether the courier is available, based on at least one of: work information of the courier; a current location of the courier; and a misdelivery event processing request time. The work information of the courier may include, for example, information on whether the courier is currently on duty. The current location of the courier may correspond to a current location of the courier terminal corresponding to the courier, for example. The misdelivery event processing request time may include a time left until a delivery correction request deadline is reached or a time corresponding to the deadline (e.g., 5 pm), for example.

For example, when the courier is currently on duty, the current location of the courier is within a predetermined distance from a wrong delivery location, and the delivery correction request deadline has not yet elapsed, the processor 230 may identify that the courier is available. In another example, when the courier is currently on duty, the current location of the courier is within the predetermined distance from the wrong delivery location, and the delivery correction request deadline has elapsed, the processor 230 may identify that the courier is not available. In yet another example, when the courier is currently on duty, the delivery correction request deadline has not yet elapsed, and the current location of the courier is out of the predetermined distance from the wrong delivery location, the processor 230 may identify that the courier is not available.

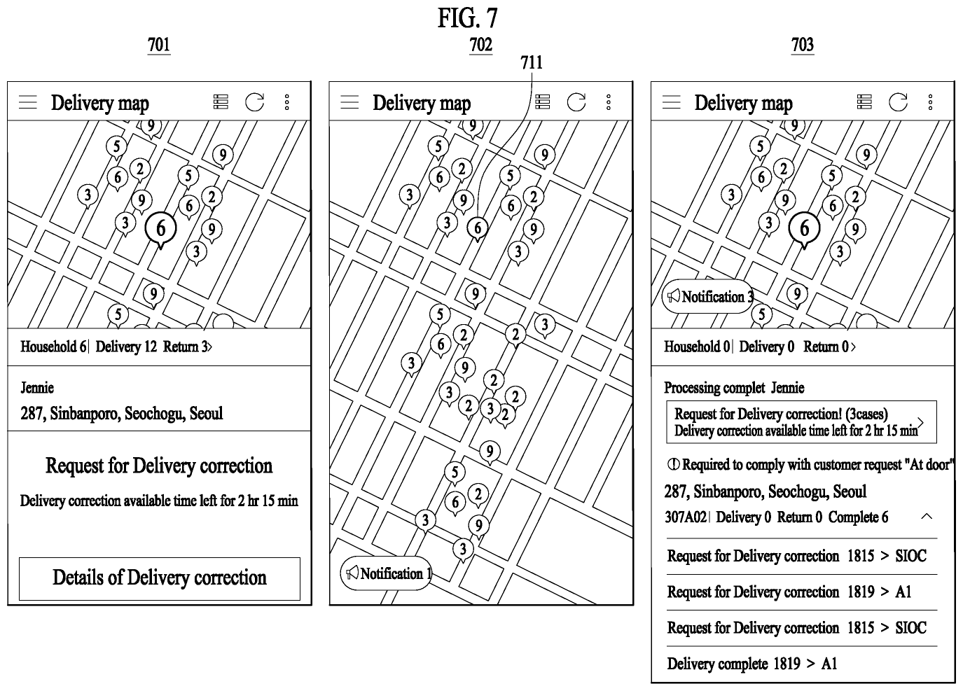

When the courier is available, the processor 230 may transmit delivery information corresponding to the misdelivery event to a first terminal (e.g., courier terminal) corresponding to the courier. In response to the transmission of the delivery information, at least part of the delivery information may be displayed on the first terminal. For a specific example, FIGS. 7 to 10 may be referred to.

In the embodiment, when the courier is not available, the processor 230 may generate processing information for an item corresponding to the misdelivery event. The processing information may include at least one of: information associated with refund of the item; and reshipment information of the item. In some cases, the processing information is pre-designated based on a user's input, and may be generated in response to a case where the courier is not available.

In some cases, when a time elapsed since a misdelivery occurrence time exceeds a predetermined time, the processor 230 may generate the processing information for the item corresponding to the misdelivery event. For example, when 12 hours or more has elapsed since the misdelivery occurrence time regardless of availability of the courier, the processor 230 may generate processing information (e.g., reshipment, refund) for an item corresponding to a misdelivery event. The processor 230 may cause an item processing procedure to be performed based on the generated information.

In the embodiment, the processor 230 may receive response information from the first terminal. The response information may include information corresponding to delivery information transmitted from the electronic apparatus 200 to the first terminal. The response information may be generated based on a user's input received at the first terminal. The response information is, for example, information corresponding to an input applied in response to delivery information displayed on the first terminal, and may include information indicating that a delivery correction is not allowed or information indicating that the delivery correction is completed. For a specific example, FIG. 11 may be referred to.

In the embodiment, when the response information corresponds to the first information, the processor 230 may generate processing information for an item. The first information may include at least one of: information indicating unallowability of processing a delivery correction for the misdelivery event; and information indicating a reason for the unallowability of the processing. The reason for the unallowability of the processing may include, for example, but not limited to, an insufficient time to perform the delivery correction, and may include various reasons why the processing of the delivery correction is not allowed. The processing information for the item may include at least one of: information associated with refund of the item; and information on reshipment of the item. In some cases, the processing information is pre-designated based on a user's input, and may be generated in response to a case where the courier is not available.

In the embodiment, when the received response information corresponds to the second information, the processor 230 may generate information indicating that the delivery correction for the misdelivery event is completed. The second information may include information indicating the completion of the delivery correction. The processor 230 may transmit the generated information to a second terminal (e.g., a customer terminal) corresponding to a customer associated with the misdelivery event. The received information may be displayed on the second terminal based on reception of the generated information.

In the embodiment, the processor 230 may identify time information which has elapsed since a misdelivery occurrence time, based on delivery information corresponding the misdelivery event. For example, in response to completion of a misdelivery, the processor 230 may receive delivery completion information (e.g., a delivery complete time, an image photographed by the first terminal in response to the completion of the delivery) from the first terminal of the courier. In response of identification of a misdelivery event, the processor 230 may identify the delivery complete time, which is indicated by the received delivery completion information, as a misdelivery occurrence time. By identifying a time which has elapsed since the identified misdelivery occurrence time, the processor 230 may identify the elapsed time information.

In this case, the processor 230 may determine whether to transmit the delivery information corresponding to the misdelivery event based on the identified time information. For example, when the identified time information falls within a range of a delivery correction request deadline requested by the customer, the processor 230 may determine the delivery information corresponding to the misdelivery event. More specifically, for example, when 5 hours has elapsed since the identified time information, that is, the misdelivery occurrence time, and the delivery correction request deadline is 6 hours, the elapsed time satisfies the delivery correction request deadline, and thus, the processor 230 may determine to transmit the delivery information corresponding to the misdelivery event to the first terminal of the courier.

When the identified time information exceeds the range of the delivery correction request deadline requested by the customer, the processor 230 may determine not to transmit the delivery information corresponding to the misdelivery event. For example, when the identified time information is 7 hours and the delivery correction request deadline is 6 hours, the elapsed time exceeds and fails to satisfy the delivery correction request deadline, and thus, the processor 230 may determine not to transmit the delivery information corresponding to the misdelivery event to the first terminal of the courier.

In the embodiment, when the delivery information corresponding to the misdelivery event is not transmitted, the processor 230 may cause processing of the item to be performed. For example, when the delivery information is not transmitted, the processor 230 may set the processing of the item as reshipment or refund, so that the item can be reshipped or refunded. A method for processing of the item may be predetermined based on a user's input. For example, in response to identification of the misdelivery event, the processor 230 may acquire in advance, based on a user's input, information that the method for processing of the item is reshipment. In this case, if the delivery information is not transmitted, the processor 230 may cause reshipment of the item to be performed.

In the embodiment, the processor 230 may receive information on a delivery correction for the misdelivery event from the first terminal (e.g., a courier terminal) of the courier. For example, the processor 230 may receive information indicating completion of the delivery correction from the first terminal. The processor 230 may provide alarm information to a second terminal (e.g., a customer terminal) of the customer based on information on the delivery correction for the misdelivery event. For example, when the information indicating the completion of the delivery correction is received from the first terminal, the processor 230 may provide the alarm information indicating the completion of the delivery correction to the second terminal. In this case, the alarm information indicating the completion of the delivery correction may be displayed on the second terminal.

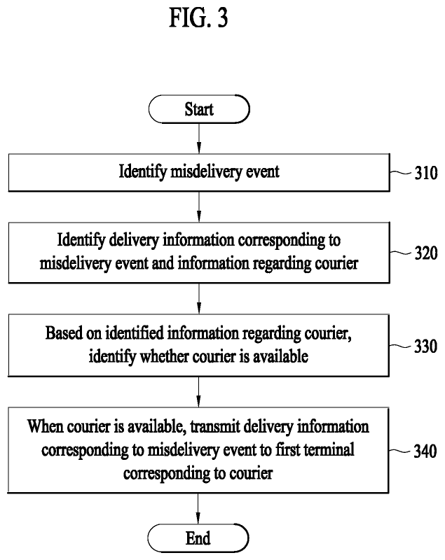

FIG. 3 is a flowchart of a control method of an electronic apparatus according to an embodiment. Operations of the control method illustrated in FIG. 3 may be in some cases performed in a different order from that depicted in the drawing. Hereinafter, a repeated description overlapping with the description provided with reference to FIGS. 1 and 2 may be omitted.

Referring to FIG. 3, in operation 310, the electronic apparatus may identify a misdelivery event. For example, the electronic apparatus may identify a misdelivery event based on a user input. In this case, the user input may include, for example, an input applied to the electronic apparatus by a customer service agent who is on the phone with the customer by wire or wirelessly. However, the present disclosure is not limited thereto, and the electronic apparatus may be connected to a customer terminal, and the misdelivery event may be identified based on information received from the customer terminal. In this case, the information received from the customer terminal may include, for example, information corresponding to the input applied to the customer terminal.

In operation 320, the electronic apparatus may identify delivery information corresponding to the misdelivery event and information on or regarding a courier. When the misdelivery event is identified, the electronic apparatus may identify the delivery information corresponding to the misdelivery event and the information on the courier. The delivery information corresponding to the misdelivery event may include, for example, information on at least one of: image information photographed in response to the misdelivery event; address information for a delivery correction for the misdelivery event and image information associated with a delivery correction address; order information of an item; a delivery correction request time for the misdelivery event; a delivery correction request deadline for the misdelivery event; and an item processing method responsive to a failure of the delivery correction for the misdelivery event. The information on the courier is information associated with the courier who misdelivered the item corresponding to the misdelivery event, and may include information on at least one of: work information of the courier; a current location of the courier; and a misdelivery event processing request time.

In operation 330, the electronic apparatus may identify whether the courier is available, based on the identified information on or regarding the courier. In the embodiment, the electronic apparatus may identify whether the courier is available, based on at least one of: whether the courier is on duty, the current location of the courier; and the request time for processing of the misdelivery event. For example, when whether the courier is on duty, the current location of the courier, and the processing request time for the misdelivery event satisfy a preset condition, the electronic apparatus may identify that the courier is available. When at least one of whether the courier is on duty, the current location of the courier, and the misdelivery event processing request time event does not satisfy the preset condition, it may be identified that the courier is not available.

In operation 340, when the courier is available, the electronic apparatus may transmit the delivery information corresponding to the misdelivery event to a first terminal corresponding to the courier. When the courier is available, the electronic apparatus may transmit the delivery information to the first terminal corresponding to the courier, so that the delivery correction can be performed.

In the embodiment, the electronic apparatus may receive response information corresponding to the delivery information from the first terminal. The response information may include, for example, at least one of: information indicating completion of the delivery correction, information indicating incompletion of the delivery correction; and information indicating unallowability of the delivery correction. When the response information includes the information indicating the completion of the delivery correction, the electronic apparatus may provide information (e.g., alarm information) indicating the completion of the delivery correction to a second terminal that is a terminal corresponding to the customer. When the response information includes the information indicating the incompletion or unallowability of the delivery correction, the electronic apparatus may generate processing information for the item. An item processing method (e.g., reshipment or refund) may be designated in advance.

In some cases, the electronic apparatus may provide information (e.g., alarm information) indicating a failure of the delivery correction to the second terminal. If information indicating a reason for the failure of the delivery correction is included in the response information, the electronic apparatus may also provide the information indicating the reason for the failure to the second terminal.

In the embodiment, when the courier is not available, the electronic apparatus may generate processing information for the item corresponding to the misdelivery event, so that processing of the item can be performed. The processing of the item may include reshipment or refund of the item, and this processing method may be designated in advance.

FIGS. 4 to 6 are diagrams for explaining a screen provided at an electronic apparatus according to an embodiment.

FIG. 4 shows an example of a screen of an electronic apparatus, where information on an item identified in response to a misdelivery event is displayed. Referring to FIG. 4, in response to identification of an order number corresponding to a misdelivery event, item information associated with the order number may be displayed on the electronic apparatus.

In one example, when the electronic apparatus receives information on an order number corresponding to a misdelivery event from a customer terminal (e.g., order number 14000063458726 in FIG. 4), information on at least one item corresponding to the order number may be displayed on the electronic apparatus. In this case, as illustrated in FIG. 4, the electronic apparatus may display the item differently according to whether or not the courier corresponding to the item is on duty.

In another example, the electronic apparatus may identify the order number based on a user input to the electronic apparatus. The electronic apparatus may display information on at least one item corresponding to the order number based on the identifying of the order number. In addition, as illustrated in FIG. 4, the electronic apparatus may display the item differently according to whether or not the courier corresponding to the item is on duty.

The information on the item may include, for example, information on at least one of: a name of the item; a volume of the item; an order quantity of the item; and an image representing the item. However, the present disclosure is not limited thereto, and a variety of information associated with the item may be included.

Referring to FIG. 4, when the courier is on duty, a text “the courier is on duty” may be displayed, and information on or regarding at least one item for which a delivery correction is available for the courier may be displayed. Here, whether the courier is on duty may be identified based on an input or information applied to the terminal corresponding to the courier, and at least one item for which a delivery correction is available may be designated in advance for each courier.

In the embodiment, when Courier A and Courier B are couriers associated with a specific order number, Courier A may be on duty and Courier B may not be on duty. In this case, on a list associated with a text “Courier on duty”, “A Body wash”, “B Juice” and “C Seaweed” may be displayed as items for each of which a delivery correction can be performed by Courier A. On a list associated with a text “Courier off duty”, “D Cleaning cloth”, “E Juice” and “F Seaweed” may be displayed as items for each of which a delivery correction can be performed by Courier B.

The order number of FIG. 4 may refer to, but not limited to, a packing unit of an item, and may also refer to, for example, a number for management of the item.

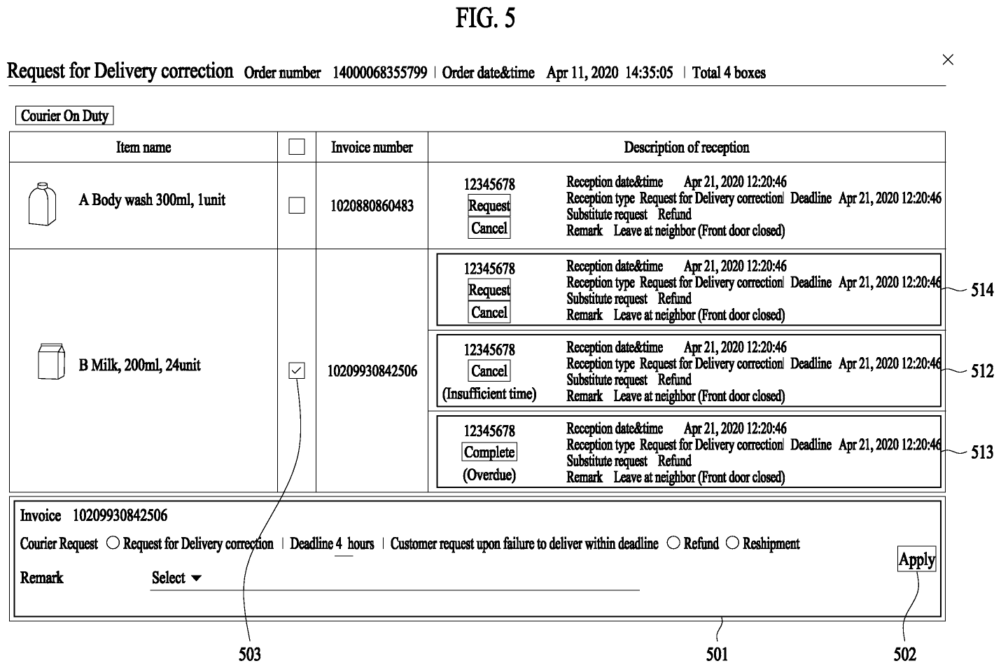

FIG. 5 illustrates an example of delivery information associated with a misdelivery event.

In the embodiment, when a courier is on duty, a delivery correction for a misdelivered item may be performed, and, in this case, at least part of delivery information associated with a misdelivery event (e.g., a reception type, a deadline, a substitute request, and a remark) may be input to an electronic apparatus. The electronic apparatus may display the delivery information associated with the misdelivery event based on the input.

Referring to FIG. 5, the delivery information associated with the misdelivery event may include information on or regarding at least one of: a reception date and time; a reception type; a deadline; a substitute request; and a remark. The reception date and time may include a time when the misdelivery event is identified or when a delivery correction for a misdelivered item is requested, and the reception type is a method for processing the misdelivered item and may include, for example, a delivery correction, refund, or reshipment. The deadline is a deadline by which completion of a delivery correction is requested when the delivery correction is input as the method for processing the misdelivered item, and may be expressed as a specific time such as a due date or as a specific period since a delivery correction reception time. The substitute request is associated with the method for processing the misdelivered item when the delivery correction is not performed (or when the delivery correction is not allowed), and may include, for example, refund or reshipment. The remark is matters referenceable for the courier in regard to the misdelivery event or the delivery correction, and may correspond to information identified from the customer. The remark may include, for example, a front door password necessary for the delivery correction, and information on or regarding how the courier responds to the absence of the customer upon the delivery correction (e.g., leaving the delivery at a neighbor).

In the embodiment, when at least part of the delivery information associated with the misdelivery event is displayed based on a user input, the electronic apparatus may receive the user input through a first area 501. For example, when an input of selecting “Request for delivery correction” is received at “Courier request” field in the first area, the reception type may be identified as a delivery correction, and when number “4” is input to “Deadline” field as illustrated, the deadline may be identified as 4 hours. When an input of selecting “Refund” is received in “Customer request upon failure to deliver within deadline” field, the replacement request may be identified as refund, and when a text is input to “Remark” field, information corresponding to the input text may be identified as “Remark.” When an input is applied to Apply button 502 after an input to each field of the first area 501 is completed, the input to each field may be finally identified as at least part of delivery information associated with the misdelivery event and then may be displayed.

In the embodiment, the electronic apparatus may control activation of the first area 501. For example, when a selection input is applied as illustrated to a first check box 503 among a plurality of check boxes associated with a displayed item, the electronic apparatus may activate the first area 501 for an item corresponding to the first check box 503. That is, the electronic apparatus may activate the first area 501, so that delivery information for the item corresponding to the first check box 503 can be input.

In the embodiment, delivery information associated with a misdelivery event may be displayed for each item. For example, the delivery information associated with the misdelivery event may be displayed for each of “A Body wash” and “B Milk.”

In the embodiment, when a courier associated with an item is identified and delivery information associated with a misdelivery event is identified, the electronic apparatus may identify whether the courier is available. Availability of the courier may be identified in consideration of a variety of information on the courier, for example, a current location of the courier, in addition to whether the courier is on duty. For example, when the courier is on duty and the location of the courier is within a predetermined distance from a wrong delivery location, the courier may be available. When the courier is available, the electronic apparatus may transmit delivery information corresponding to the misdelivery event to a terminal corresponding to the courier, that is, a courier terminal. In this case, the delivery information may be displayed on the courier terminal, and the courier may perform a delivery correction based on the displayed information.

When the delivery correction is completed or when the delivery correction is not completed for a specific reason, the courier terminal may transmit information on a result of the delivery correction to the electronic apparatus based on a user's input. The electronic apparatus may display the information on the result of the delivery correction based on the received information.

For example, when it is determined, based on the received information, that it is difficult to complete the delivery correction due to insufficient time or that the delivery correction is not allowed due to elapse of a deadline, the electronic apparatus may display, in a second area 512 or a third area 513, a text indicating the reason why the delivery correction is difficult. Before the information is received, displaying in the second area 512 and the third area 513 may be omitted.

In another example, when a delivery correction is in progress, the displaying in the second area 512 and the third area 513 may be maintained but each area may be displayed as an inactive state, and upon receiving information corresponding to the second area 512 and the third area 513, one of the second area 512 and the third area 513 may be displayed as an active state. In this case, a fourth area 514 may be changed to an inactive state and displayed.

However, the present disclosure is not limited to the above example, and information on the progress of the delivery correction may be displayed while at least a portion of what is displayed in the fourth area 514 is changed. For example, the information on the progress of the delivery correction may be displayed while a portion corresponding to the “Request” is changed to a text such as “Insufficient time” or “Overdue.”

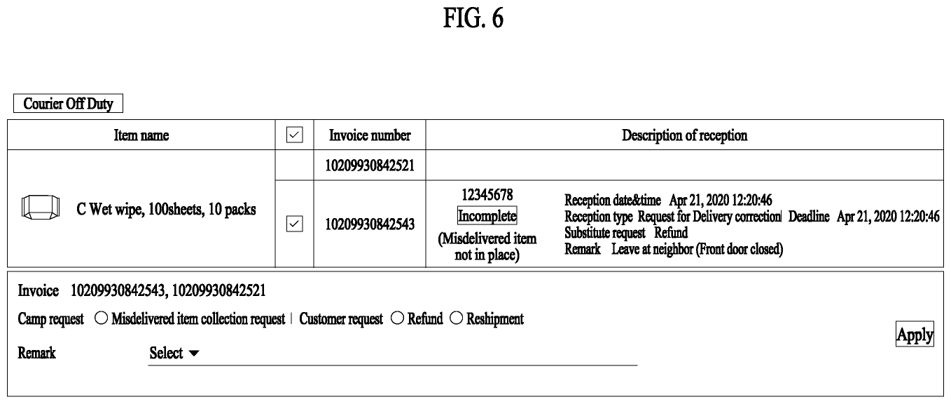

FIG. 6 shows an example of a screen displayed on an electronic apparatus when a courier is off duty. Specifically, FIG. 6 shows an example of a screen displayed on the electronic apparatus when a misdelivery event is identified (or a delivery correction is requested) but the delivery correction is not completed for a specific reason and a courier is off duty.

Referring to FIG. 6, when the delivery correction is not completed because a misdelivered item does not exist at a wrong delivery location, the electronic apparatus may display a text “Misdelivered item not in place” which indicates the reason. The electronic apparatus may receive an input associated with a method for processing the misdelivered item in response to incompletion of the delivery correction. For example, in response to the incompletion of the delivery correction for the misdelivered item, an input regarding whether to refund or reship the item may be received. Since a method for receiving the input is described with reference to FIG. 5, a more detailed description thereof will be omitted.

According to an embodiment, at least some of the screens illustrated in FIGS. 4 to 6 may be displayed on the customer terminal. In this case, the above-described transmission of information from the electronic apparatus to a courier terminal may correspond to transmission of information to the courier terminal through the electronic apparatus. In addition, the above-described transmission of information from the courier terminal to the electronic apparatus may correspond to transmission of information from the courier terminal to a customer terminal through the electronic apparatus. In this case, the electronic apparatus may be implemented as a server, but not limited thereto.

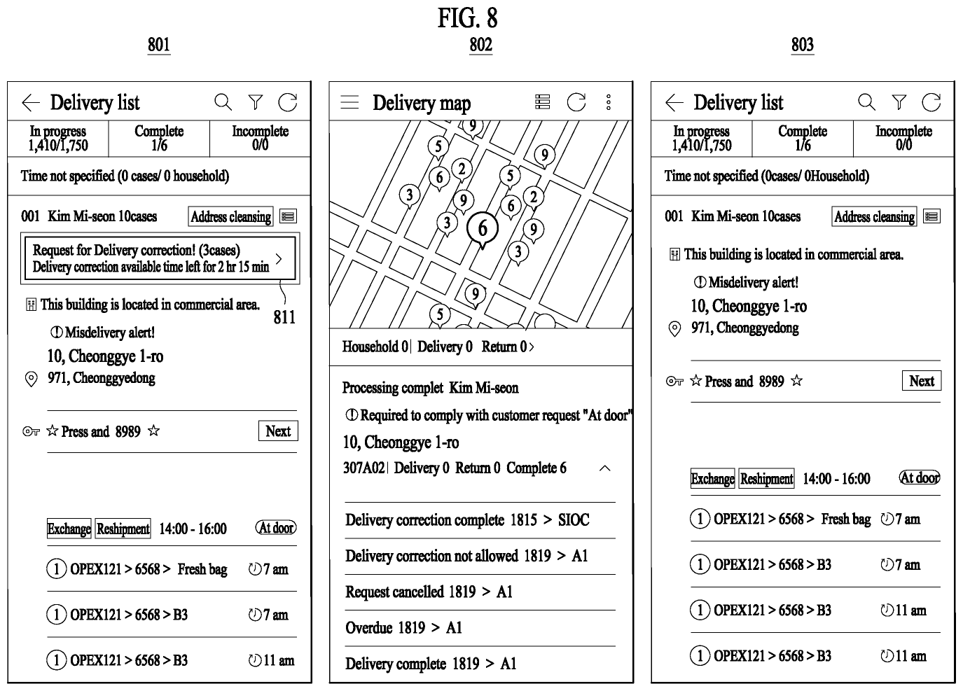

FIGS. 7 and 8 are diagrams for describing an example in which information provided from an electronic apparatus is displayed on a first terminal corresponding to a courier according to an embodiment.

FIG. 7 illustrates an example of a screen displayed on the first terminal corresponding to a courier, that is, a courier terminal, when delivery information associated with a misdelivery event is received.

Reference numeral 701 of FIG. 7 indicates an example in which, in response to receiving the delivery information associated with misdelivery event, notification information indicating the reception of the delivery information is displayed on the first terminal. According to reference numeral 701, when the delivery information associated with the misdelivery event is received at the first terminal, notification information indicating the reception of the delivery information may be displayed on the first terminal. The notification information may include, for example, information on or regarding at least some of the following: a text indicating that a delivery correction is requested, a deadline of the delivery correction; address information associated with the delivery correction; and customer information associated with the delivery correction.

The notification information may be displayed in the form of a pop-up window at the bottom of the screen as illustrated, but not limited thereto.

According to an embodiment, a screen corresponding to the address information associated with the delivery correction may be displayed along with the provision of the notification information. Specifically, a map where the address information associated with the delivery correction, that is, a screen where a delivery correction location is displayed, may be displayed on the first terminal. In this case, a user of the first terminal, that is, a courier, may intuitively recognize the delivery correction location.

Reference numeral 702 indicates an example of a screen of the first terminal, where the displaying of the notification information is stopped and information on or regarding the delivery correction location 711 is displayed. According to reference numeral 702, the delivery correction location 711 may be displayed differently from other delivery locations. For example, the delivery correction location 711 may be displayed in different color or different size from other delivery locations.

Reference numeral 703 indicates an example of a screen where detailed information on or regarding the delivery correction location 711 is displayed. In the embodiment, when an input (e.g., touch) regarding an area corresponding to the delivery correction location 711 is received, a delivery correction request deadline, customer information associated with the delivery correction, and address information of the delivery correction location may be displayed at the bottom of the screen as shown in reference numeral 703. However, the present disclosure is not limited thereto, and, for example, at least in part of delivery information associated with a misdelivery event may be displayed.

FIG. 8 shows an example of a screen displayed on a first terminal in regard to performing a delivery correction.

When a delivery correction is requested in response to identifying a misdelivery event regarding a specific customer (e.g., Kim Mi-seon), the electronic apparatus may transmit delivery information associated with the misdelivery event to the first terminal corresponding to the misdelivery event. The first terminal may display at least part of the received delivery information on a screen associated with the specific customer. For example, at least part of the received delivery information as shown in reference numeral 801 may be displayed in a first area 811.

In the embodiment, a variety of information associated with an item delivery may be displayed in areas other than the first area 811. Information displayed in areas other than the first area 811 may include, but not limited thereto, information displayed at a time when an item is misdelivered, that is, information displayed when the item is delivered for the first time (e.g., notice information regarding the delivery of the item, a schedule list associated with deliveries of other items).

Reference numeral 802 indicates an example of a screen displayed on the first terminal in response to completion of the delivery correction. Although not specifically illustrated, the first terminal may receive a user's input corresponding to the completion of the delivery correction. Based on the reception of the input corresponding to the completion of the delivery correction, the first terminal may display a screen as shown in reference numeral 802.

According to the embodiment, in response to the completion of the delivery correction, the first terminal may display a screen as shown in reference numeral 803. According to reference numeral 803, the displaying in the first area 811 may be stopped in response to the completion of the delivery correction.

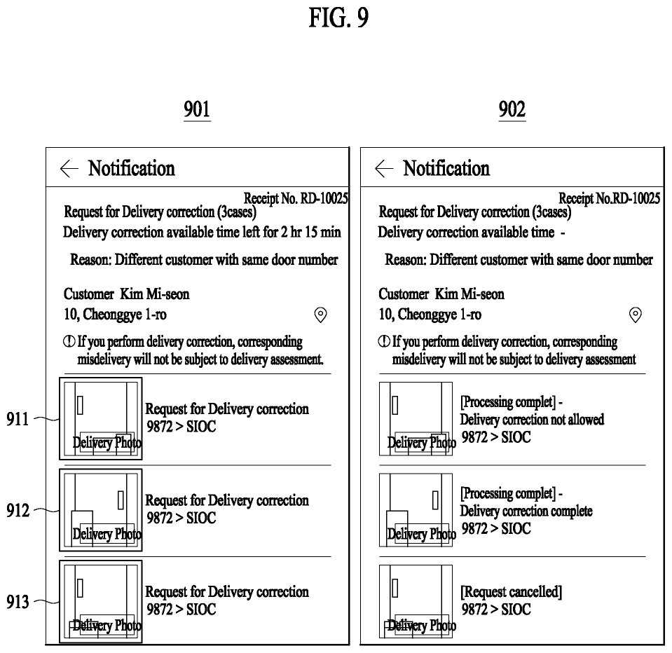

FIG. 9 is a diagram for describing another example in which information provided from an electronic apparatus is displayed on a first terminal corresponding to a courier according to an embodiment.

In the embodiment, a screen corresponding to reference numeral 901 and a screen corresponding to reference numeral 902 may be displayed on the first terminal corresponding to the courier. According to reference numeral 901, image information (e.g., first image information 911) photographed in response to a misdelivery event may be displayed on the first terminal. The image information for each item for which a delivery correction is requested may be displayed. For example, since a case where there are three items for each of which a delivery correction is requested is shown, image information (e.g., first image information 911, second image information 912, and third image information 913) for each of the three items may be displayed, as shown in reference numeral 901.

In the embodiment, when a delivery correction is completed or failed, a screen indicating completion or failure of the delivery correction may be displayed on the first terminal. Specifically, a user input may be received in the first terminal in response to the completion or failure of the delivery correction. For example, when the delivery correction is completed, a first input corresponding to completion may be received at the first terminal, and when the delivery correction fails, a second input corresponding to failure (e.g., correction delivery not allowed, correction delivery cancelled) may be received at the first terminal. Based on a result of the delivery correction, that is, reception of an input associated with completion or failure, the first terminal may display information on the result of the delivery correction.

In an embodiment, when there is a plurality of items for each of which a delivery correction is required, information on a result of the delivery correction for each of the plurality of items may be displayed, as shown in reference numeral 902.

In the embodiment, in addition to delivery information associated with a misdelivery event, a variety of information associated with a delivery correction may be displayed on the first terminal. For example, alarm information for the courier may be displayed on the first terminal. The alarm information for the courier may include, for example, a text “If you perform a delivery correction, a corresponding misdelivery will not be subject to delivery assessment.” However, the present disclosure is not limited thereto, and a variety of information guided to the courier in regard to a delivery may be displayed.

In some cases, image information associated with a delivery correction address may be displayed on the first terminal. The image information associated with the delivery correction address may include information on an image photographed based on a previous delivery that was correctly performed to a correct delivery location of a misdelivered item. More specifically, for example, the image information associated with the delivery correction address is an image photographed for an area in front of a door of the correct delivery location, that is, an image of an item placed in front of the door.

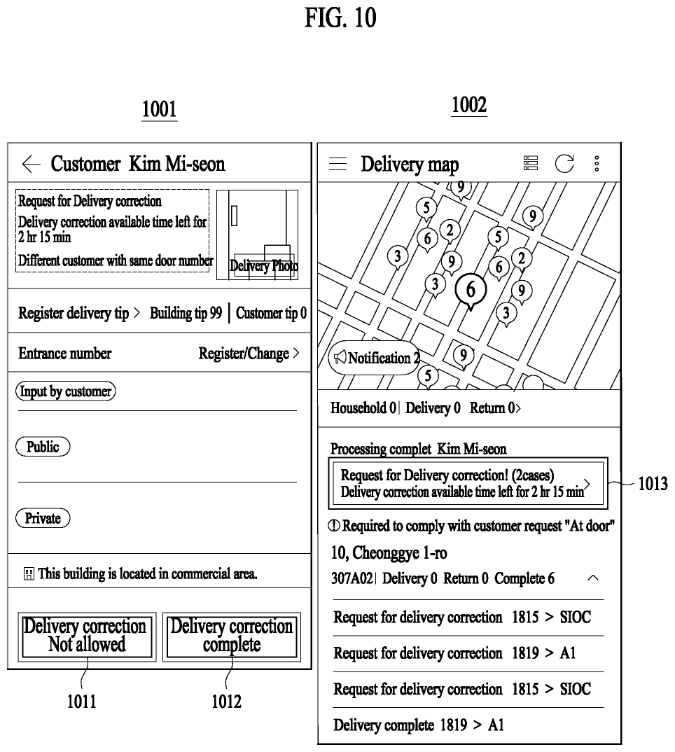

FIG. 10 is a diagram for describing yet another example in which information provided from an electronic apparatus is displayed on a first terminal corresponding to a courier according to an embodiment.

In the embodiment, a screen corresponding to reference numeral 1001 and a screen corresponding to reference numeral 1002 may be displayed on the first terminal corresponding to the courier. Referring to reference number 1001, at least part of delivery information associated with a misdelivery event and an input button for receiving a user's input may be displayed on the first terminal. At least part of the delivery information associated with the misdelivery event may include for example, a deadline of a delivery correction, which corresponds to “delivery correction available time left for 2 hours and 15 minutes”, an image photographed in response to the misdelivery event (or an image associated with the delivery correction address), and a remark associated with the delivery correction, which corresponds to “Different customer with the same door number.”

In some cases, when there is information filled directly by a customer through a customer terminal, the filled information may be displayed in “Input by customer” field, when there are remark for a public entrance door regarding a delivery correction location, information on the remark may be displayed in “Public” field, or when there is a remark for an individual household regarding the delivery correction location, information on the remark may be displayed in “Private” field.

However, this is merely an example and is not limited thereto, and at least part of the above-described information may be omitted or other information may be displayed.

According to reference numeral 1001, a button 1011, 1012 for inputting a delivery correction not allowed or a delivery correction complete may be displayed on the first terminal. The first terminal may generate information based on an input to the button 1011, 1012 and transmit the information to the electronic apparatus. For example, when an input to the Delivery Correction Not Allowed button 1011 is received, the first terminal may generate information corresponding to the delivery correction not allowed and transmit the generated information to the electronic apparatus. When an input to the Delivery Correction Complete button 1012 is received, the first terminal may generate information corresponding to the correction delivery complete and transmit the generated information to the electronic apparatus.

Reference numeral 1002 indicates an example of a screen displayed on the first terminal in response to completion of the delivery correction. Specifically, reference numeral 1002 indicates an example of a screen displayed on the first terminal based on an input to the Delivery Correction Complete button 1012 in reference number 1001.

In the embodiment, when the delivery correction is completed, a message “processing complete” indicating that the delivery correction is completed may be displayed on the first terminal, as shown in reference number 1002. In some cases, there may be a plurality of items for each of which a delivery needs to be corrected for “Kim Mi-seon”, and, in this case, delivery information reflecting a number of items for which deliveries have been corrected may be displayed. For example, when there are three items for which deliveries need to be corrected and a delivery correction for one item is completed, a message indicating a number of items for each of which deliveries needs to be corrected may be displayed in a first area 1013 as “2 cases” as illustrated.

FIG. 11 is a diagram for describing response information received from a first terminal of an electronic apparatus according to an embodiment. Specifically, FIG. 11 is a diagram for describing response information received from the first terminal in response to a delivery correction not allowed.

In the embodiment, a screen for inputting the response information may be displayed on the first terminal. For example, as shown in reference number 1101, a screen including an area for selecting at least one of the following which is associated with a reason for the delivery correction not allowed may be displayed on the first terminal: insufficient time; a delivery item not in place; and a failure to find a customer address. When an input of selecting the at least one is received and an input to a Delivery Correction Processed As Not Allowed button 1111 is received, the first terminal may generate response information corresponding to the input and transmit the response information to the electronic apparatus.

In the embodiment, the first terminal may receive a text input to a first area 1112 associated with “Detailed reason.” In this case, the first terminal may generate the selected information (at least one of the insufficient time, the delivered item not in place, and the failure to find the customer address) and a text input corresponding to the input of the detailed reason as response information, and transmit the response information to the electronic apparatus.

In the embodiment, reference numeral 1101 may be displayed based on an input to the Delivery Correction Processed As Not Allowed button 1111 in reference numeral 1001 of FIG. 10. However, the present disclosure is not limited thereto, and a screen corresponding to reference numeral 1101 may be displayed based on an input corresponding to the delivery correction not allowed.

Reference numeral 1102 indicates an example of a screen displayed on the first terminal after response information is generated based on an input to the Delivery Correction Processed As Not Allowed button 1111 and is then transmitted from the first terminal to the electronic apparatus. Specifically, according to reference numeral 1102, a message indicating that processing of a delivery correction not allowed is completed, for example, a text indicating that the processing of the delivery correction not allowed is completed, may be displayed on the first terminal. Such a text may be overlapped on other screens, but not limited thereto, and may be displayed to occupy at a specific location, for example.

In the embodiment, when the processing of the correction delivery not allowed is completed, a related delivery may be displayed on the first terminal. Specifically, an invoice number of the related delivery may be displayed on the first terminal, as shown in reference numeral 1103. Details of the delivery item selected based on an input of selecting the related delivery may be displayed on the first terminal.

Here, the related delivery may include, for example, but is not limited thereto, an item which is ordered by the same customer as that of an item completed in processing of a delivery correction not allowed, and of which a delivery is scheduled or completed.

According to the present embodiments, an electronic apparatus and a control method thereof enable processing of an item corresponding to a misdelivery event based on availability of a courier, and therefore, it is possible to manage a misdelivery more effectively by reflecting a delivery situation associated with the misdelivery event.

In addition, the electronic apparatus and the control method thereof identify delivery information corresponding to the misdelivery event and information on a courier, and therefore, it is possible to provide more accurate information associated with the misdelivery event to a customer and enable more effective management for the misdelivery event.

The apparatus described herein may include a permanent storage such as a disk drive, a communication port for handling communications with external devices, and user interface devices such as a touch panel, a key, and a button. The methods that are implemented as software modules or algorithms may be stored as program instructions or computer-readable codes executable by the processor on a computer-readable recording medium. Here, examples of the computer-readable recording medium include magnetic storage media (e.g., read only memory (ROM), random access memory (RAM), floppy disk, or hard disk), optically readable media (e.g., compact disk-read only memory (CD-ROM) or digital versatile disk (DVD)), etc. The computer-readable recording medium may be distributed over network coupled computer systems, and thus, the computer-readable code may be stored and executed in a distributed fashion. This medium may be read by the computer, stored in the memory, and executed by the processor.

The present embodiments may be described in terms of functional block components and various processing steps. Such functional blocks may be realized by any number of hardware and/or software components configured to perform specified functions. For example, embodiments may employ various integrated circuit (IC) components, e.g., memory elements, processing elements, logic elements, look-up tables, and the like, which may carry out a variety of functions under the control of one or more microprocessors or other control devices. Similarly, where the elements are implemented using software programming or software elements, the present embodiments may be implemented with any programming or scripting language such as C, C++, Java, assembler language, or the like, with the various algorithms being implemented with any combination of data structures, objects, processes, routines or other programming elements. Functional aspects may be implemented in algorithms that are executed on one or more processors. Furthermore, the embodiments described herein could employ any number of conventional techniques for electronics configuration, signal processing and/or control, data processing and the like. The terms “mechanism,” “element,” “means,” and “configuration” are used broadly and are not limited to mechanical or physical embodiments. These terms may include meaning of a series of routines of software in association with a processor, for example.

The above-described embodiments are merely examples, and other embodiments may be implemented within the scope of the following claims.

1. A method operable by an electronic apparatus for managing a delivery of an item, the electronic apparatus comprising a transceiver, a memory, and a processor, the electronic apparatus configured to communicate with a customer terminal and a courier terminal, the method comprising:
receiving, from the customer terminal via the transceiver, information identifying a misdelivery event in which the item was delivered to an incorrect delivery location different from a correct delivery location associated with the delivery;
identifying, via the processor, delivery information corresponding to the misdelivery event and information regarding a courier corresponding to the misdelivery event;
determining, via the processor and based on the identified information regarding the courier, whether the courier is available; and
in response to determining the courier is available, causing the transceiver to transmit the delivery information corresponding to the misdelivery event to the courier terminal to facilitate re-delivery of the item to the correct delivery location,
wherein the determining whether the courier is available comprises determining, based on at least one of work information of the courier, a current location of the courier, or a request time for processing of the misdelivery event, whether the courier is allowed to perform a delivery correction.

2. The method of claim 1, further comprising, in response to determining the courier is not available, generating processing information for the item corresponding to the misdelivery event.

3. The method of claim 2, wherein the processing information comprises at least one of: information associated with refund of the item, or reshipment information of the item.

4. The method of claim 1, wherein the performing of the delivery correction comprises performing re-delivery of the item corresponding to the misdelivery event based on a spare quantity of the courier.

5. The method of claim 1, further comprising:
receiving response information corresponding to the transmitted delivery information from the courier terminal; and
in response to determining the received response information corresponds to first information, generating processing information for the item corresponding to the misdelivery event.

6. The method of claim 5, wherein the response information is generated based on a user input received at the courier terminal.

7. The method of claim 5, wherein the first information comprises at least one of: information indicating unallowability of processing a delivery correction for the misdelivery event; or information indicating a reason for the unallowability of the processing.

8. The method of claim 7, further comprising:
in response to determining the received response information corresponds to second information, generating information indicating that the delivery correction for the misdelivery event is completed; and
transmitting the generated information to the customer terminal.

9. The method of claim 1, further comprising identifying, based on the delivery information corresponding to the misdelivery event, time information elapsed since a misdelivery occurrence time,
wherein the transmitting of the delivery information corresponding to the misdelivery event comprises determining, based on the time information, whether to transmit the delivery information corresponding to the misdelivery event.

10. The method of claim 9, further comprising, in response to determining the delivery information corresponding to the misdelivery event is not transmitted, performing processing of the item corresponding to the misdelivery event.

11. The method of claim 1, wherein the delivery information corresponding to the misdelivery event comprises the following:
image information photographed in response to the misdelivery event;
address information for a delivery correction for the misdelivery event and image information associated with an address for the delivery correction;
order information of the item corresponding to the misdelivery event;
a delivery correction request time for the misdelivery event;
a delivery correction request deadline for the misdelivery event; and
an item processing method responsive to a failure of the delivery correction for the misdelivery event.

12. The method of claim 1, wherein the misdelivery event is identified based on information received from the customer terminal,
wherein the method further comprises:
receiving information regarding processing of a delivery correction for the misdelivery event from the courier terminal; and
providing alarm information to the customer terminal based on the information regarding the processing of the delivery correction for the misdelivery event.

13. An electronic apparatus for managing a delivery of an item, the apparatus comprising:
a transceiver configured to communicate with a customer terminal and a courier terminal;
a memory; and
a processor,
wherein the processor is configured to:
receive, from the customer terminal via the transceiver, information identifying a misdelivery event in which the item was delivered to an incorrect delivery location different from a correct delivery location associated with the delivery,
identify delivery information corresponding to the misdelivery event and information regarding a courier corresponding to the misdelivery event,
determine, based on the identified information regarding the courier, whether the courier is available,
in response to determining the courier is available, cause the transceiver to transmit the delivery information corresponding to the misdelivery event to the courier terminal to facilitate re-delivery of the item to the correct delivery location, and
determine, based on at least one of work information of the courier, a current location of the courier, or a request time for processing of the misdelivery event, whether the courier is allowed to perform a delivery correction.

14. A non-transitory computer-readable recording medium having recorded thereon a program, which, when executed by a computer, performs the method of claim 1.
